(19) United States
(12) Patent Application Publication
(10) Pub. No.: US 2004/0058717 A1
(43) Pub. Date: Mar. 25, 2004

(54) Notification of wireless hotspots

(76) Inventors: James Thomas Edward McDonnell, (US); John Deryk Waters, (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/629,846

(22) Filed: Jul. 30, 2003

(30) Foreign Application Priority Data
Jul. 31, 2002 (GB) 0217789.7

(51) Int. Cl. H04M 1/00; H04B 1/38

(52) U.S. Cl. 455/567; 455/456.1

(57) ABSTRACT

A communication system comprising notification means arranged to locate a mobile unit and to transmit a notification to said mobile unit via a first telecommunication network when said mobile unit moves within the vicinity of an access node of a second network.

### BACKGROUND OF THE INVENTION

The use of cellular wireless telecommunication networks for communication with and between mobile devices, ordinarily mobile phones, is well established. The communication is achieved by establishing a network of base station transceivers that define a pattern of communication cells. Each cell ordinarily has a single base station associated with it and provides coverage to mobile units within the individual cell. The size of individual cells varies depending upon the anticipated density of mobile users within the cell. However, the size of the cell is fixed. Ideally, a mobile phone user is always within range of one or more base stations.

It is becoming increasingly popular to utilise mobile phones and other mobile devices for the wireless transmission of data other than voice signals. Examples of other data that are being transmitted using cellular communication systems include e-mails and picture data. However, the standard data transmission rate of 9.6 kbps achievable using conventional cellular communication networks such as GSM networks, although entirely adequate for digital voice transmission, is comparatively slow for the transmission of non-voice data. This makes the use of cellular systems for the transmission of such non-voice data particularly unattractive because the data transmission times are long, which is in its self an inconvenience, and consequently the cost of the transmission is relatively high.

Parallel to the development of the cellular communication systems for voice communication, other wireless data transmission systems have been developed. An example of such systems are those that adhere to the family of related wireless standards referred to as IEEE 802.11. This wireless transmission standard has been primarily developed to allow wireless data communication between individual computer units. The 802.11 systems also utilise a transceiver base station, the coverage of which defines a transmission cell in which computer peripherals may communicate with each other. The 802.11 transceiver also allows suitably equipped mobile devices to communicate with a fixed, wired network connected to the transceiver. However, the range of 802.11 transceivers is relatively small, about 30 metres, and is thus not suitable as an external cellular system providing total coverage, as is achieved by a cellular telephone communication system. However, the rate of transmission that is achievable using the 802.11 system is relatively high. For example systems utilising the 802.11B standard employ a raw data transmission rate of approximately 11 Mbps, which is significantly faster than that possible using only the cellular telecommunication network.

It would therefore be attractive to provide a system that notified a mobile device compatible with an 802.11 system, or other high speed data communication system, when that mobile device was within range of the 802.11 system. United States patent publication number US 2001/0043148 discloses a cellular telecommunication based system that determines when a mobile unit is within the vicinity of a particular geographical location, the geographical location being associated with an access point which is itself a specific information providing device. On detection that the mobile unit which has come within range of the access point, information in the form of advertising and the like, specific to the information provider at the geographical location, is provided to the mobile unit. However, this system does not provide high speed data communication.

### SUMMARY OF THE INVENTION

According to a first aspect of the present invention there is provided a communication system comprising notification means arranged to locate a mobile unit and to arrange to transmit a notification to said mobile unit via a first telecommunication network when said mobile unit moves within the vicinity of an access node of a second network.

The notification may comprise a voice message, text message or email. The notification may contain directions towards the access node in addition to, or instead of, just the location of the access node. This list is not exhaustive.

The notification may additionally or alternatively comprise an electronic token. However, more preferably the notification is an offer to receive an electronic token. The electronic token is preferably only transmitted when said mobile unit communicates with said second network via said access node. The electronic token may have a redeemable monetary value, with the at least one access node being located at a retail outlet at which the electronic token is redeemable. Alternatively, the electronic token may be redeemable against goods or services at other locations.

Alternatively, the electronic token may comprise a gaming credit. For example, the token may be in the form of a password or code that may be entered into widely used gaming consoles to provide enhanced game play for one or more games.

Preferably, the mobile unit is capable of communicating with both the first and the second networks, with the mobile unit being capable of communication with the second network only when within a predetermined range of the access node.

Alternatively, a further mobile unit may be provided for communication with the second network, the further mobile unit also being capable of communication with the second network only when in within a predetermined range of the access node. This provides the possibility that the notification signal is sent to a first mobile unit, such as a conventional mobile phone, that is compatible with the first telecommunication network but not compatible with the second network, with a second mobile device, such as a state of the art personal organiser, that is compatible with only the second network being used to access said second network.

Preferably, the rate of communication with the second network is at a higher data rate than the rate of communication with first network. This is irrespective of whether the same mobile unit is used for communication with both networks, or whether a first mobile unit is used for communication with the first network and a second mobile unit is used for communication with the second network.

Preferably, the location of said access node is stored on a storage medium in communication with the first network. The storage medium may be an integral part of the first network, or may equally be remote from the first network but in communication with it.

The first network may be a cellular communication system, such as a GSM or 3G telecommunication system. The second network may be a wireless LAN utilising the 802.11B standard, or may be a 3G (third generation telecommunication system) Pico-cell or other suitable communication scheme.

According to a second aspect of the present invention there is provided a method of notifying a mobile device user to the presence of a network access node, the method comprising: providing a first network in communication with said mobile device; determining the location of said mobile device; and transmitting a notification from said first network to said mobile device when said mobile device moves within the vicinity of a network access node of a second network.

The notification may comprise a voice message, text message or email. The notification may contain directions towards the access node in addition to, or instead of, just the location of the access node. This list is not exhaustive.

The notification may additionally or alternatively comprise an electronic token. The electronic token is preferably only transmitted when said mobile unit communicates with said second network via said access node. The electronic token may have a redeemable monetary value, the electronic token being redeemable at a retail outlet at which the network access node is located. Alternatively, the electronic token may be a gaming credit, or music download or some other non-tangible item believed to be of value or worth to users.

Preferably, the location of the network access node is held in a storage medium, the storage medium being in communication with the first network.

Preferably, communication with the second network is achieved using the mobile device when the mobile device is within a predetermined range of the network access node.

Alternatively, communication with the second network may be achieved using a further mobile device when the further mobile device is within a predetermined range of the network access node.

Preferably, communication with the second network occurs at a greater data rate than communication with the first network. This is irrespective of whether the same mobile device is used to communicate with both networks or whether different devices are used for the individual networks.

### BRIEF DESCRIPTION OF THE DRAWING

An embodiment of the present invention will now be described, by way of example only, with reference to the accompanying FIGURE, which is a schematic representation of an information system according to the present invention.

### DESCRIPTION OF THE PREFERRED EMBODIMENTS

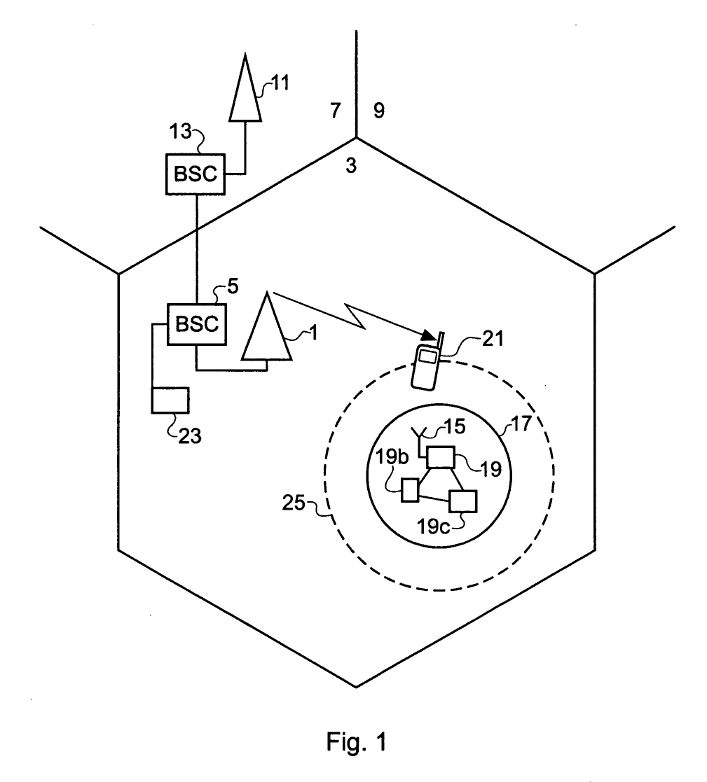

A base station 1 is located within a cell 3 of a cellular wireless telecommunication system, such as a GSM system. The base station 1 provides coverage to mobile cellular communication devices located anywhere within the cell 3. Connected to the base station 1 is a base station controller 5. The cell 3 is shown as hexagonal in shape in accordance with conventional representation, but may not physically have that shape in reality. Adjacent to cell 3 are further cells 7 and 9. Within cell 7 is a further base station 11 connected to a further base station controller 13. The base station controller 13 in the second cell 7 is connected to the base station controller 5 within the first cell 3. A similar arrangement of base station and base station controller is in adjacent cell 9 (not shown in FIG. 1 for sake of clarity). The base station controllers may be interconnected to one or more master controllers (not shown).

A second network 19 comprising one or a number of interconnected network elements is located within the first cell 3. The second network includes a wireless transceiver antenna 15, the range of which is denoted by the solid circle 17 enclosing the transceiver 15. The second network may also include wired access points 19b and/or gateways 19c to other networks such as the Internet. In use, a person may move to a position such that they and their mobile telecommunication device 21 become located within the communication cell 3. Additionally, a second network location register 23 is connected to the base station controller 5 within the first telecommunication cell 3, the location register storing details of at least the location of the wireless transceiver 15.

In operation, the mobile telecommunication device 21 communicates with the base station 1 and base station controller 5 of the first cell 3 in accordance with conventional cellular communication techniques. For example, communication between the base station 1 and mobile device 21 may be achieved in accordance with GSM or GPRS protocols. Thus the mobile device 21 is able to communicate with other mobile devices in other cells by virtue of the interconnected properties of the base station controllers 5, 13 within the different cells. The cellular telecommunication system is denoted the first network within the present invention.

The wireless transceiver 15 connected to the second network 19 preferably operates in accordance with one of the family of IEEE 802.11 standards. This allows relatively high speed wireless data communication, for example approximately 11 Mbps, between the second network 19 and a suitably configured wireless device. The wireless transceiver 15 may be located at any geographical location at which it will be convenient for users with appropriately configured mobile devices to log on to the second network 19. For example, the wireless transceiver 15 may be located at a shopping mall, within an individual retail outlet such as a restaurant or cafe or indeed any other retail outlet that may wish to provide the wireless service. The second network 19 may be an internal network, in the manner of a Intranet, wholly contained within the retail outlet or premises at which it is located. For example, the second network 19 may in fact be an internal company network, with the wireless transceiver 15 being located within the company offices. Alternatively, the second network 19 may additionally or alternatively provide wider connectivity to other networks, for example such as the Internet and World Wide Web. Such extended connectivity would be particularly advantageous to users as it would allow non-location specific information to be accessed, along with data such as emails etc.

The geographical location of the second network, and in particular the wireless transceiver 15, is stored in the location register 23 that is in communication with at least one of the base station controllers of the cellular telecommunication networks. The location register 23 may be an integral part of the cellular telecommunication network or may be remotely stored and accessed by the telecommunication system. Thus, the base station controller 5 within the first cell 3 effectively knows the location of the wireless transceiver 15 of the second network 19. The base station can either tell each person within its cell the location of the second network, or preferably gives information about the second network only when a user is relatively near it. Using conventional wireless telecommunication techniques such as triangulation using a number of base stations that are all in contact with the mobile unit 21, the location of a mobile unit 21 in communication with the wireless telecommunication system can be determined. When the mobile device 21 moves within a predetermined range, denoted by the broken circle 25 surrounding the second network 19, the base station controller 5 is arranged to send a notification to the mobile device 21 that the user is within the vicinity of the wireless transceiver 15 and the second network 19. As an aside, the area covered by the wireless transceiver 15 is sometimes referred to as a “wireless hotspot” because it represents a localised area in which relatively high rate data communication can be achieved. Having received the notification, the user of the mobile device 21 is free to move within the range of the wireless transceiver 15 to establish a wireless connection with the second network 19 at a substantially higher data rate than would be achievable over the cellular telecommunication system.

Other information associated with wireless transceiver 15, also known in the art as an access point, may be stored in the location register 23. For example, details of the coverage of the wireless transceiver 15 may be stored. The coverage provided by a wireless transceiver conforming to an 802.11 standard is not necessarily a symmetrical area centred at the transceiver. It may therefore be advantageous to store information concerning the details of the coverage pattern provided by a particular transceiver. Additionally, details of the data transmission rate supported by the transceiver, the pricing structure set by the hotspot provider for the transceiver and details concerning the business activity of the hotspot provider may all be stored. In preferred embodiments the hotspot provider(s) provide the location and additional information for each wireless transceiver 15 to the cellular telecommunication system provider to enable the location register 23 to be kept up-to-date.

As a consequence, the notification sent to the mobile device 21 may include one or more of these details and may be tailored in accordance with the available information. For example, where a hotspot provider considers their pricing structure to be particularly competitive this information may be included in the notification. Equally, details of the goods or services provided at the location of a hotspot may be included in the notification.

The notification sent to the mobile device 21 may be a recorded voice message or a text message or, in the case of a GPRS telecommunication system, may be an email or a graphic message. The notification may additionally contain details of the location of the wireless transceiver 15. For example, the notification may specify the retail outlet at which the transceiver 15 is located, or may provide an indication of the direction in which to move to reach the wireless transceiver 15.

The mobile device 21 may be capable of communication with both the cellular telecommunication system and the second network 19. However, it is equally probable that a second mobile device is used to connect to the second network 19 via the wireless transceiver 15. Access to the second network 19 may be entirely free and open, or may alternatively be restricted to either registered users or on a “pay as you go” basis.

In preferred embodiments of the present invention the notification transmitted to the mobile device 21 when it is within a predetermined range of the second network 19 includes an electronic token. The electronic token may be in the form of a redeemable voucher for goods or services either provided at the location at which the transceiver 15 is located, or goods or services associated with that location. Alternatively, the token may be redeemable at any other retail outlet or against the entrance fee for a museum or attraction or the like. Thus if the wireless transceiver 15 is located at a coffee shop the electronic token may be redeemable against coffee purchased at the coffee shop so as to encourage users to visit the coffee shop and to linger therein. Further, the time period over which the token remains valid may be relatively short, so as to encourage users to proceed to the location of the transceiver 15, i.e. the coffee shop, immediately when they might otherwise not have done so at that particular time. In further embodiments, the electronic token may be a gaming credit, for example a password or code for use with a particular electronic game. For example, the gaming credit could award one or more extra free lives to a user of a particular game. In further embodiments the electronic token may not be transmitted, or only made valid, until actual communication with the second network is made.

In further embodiments of the present invention, the data rate at which communication occurs with the second network may be reduced from the theoretical maximum possible data rate, although the reduced data rate is preferably greater than that achievable using the wireless telecommunication network. Thus users are required to remain connected to the second network longer than would otherwise be necessary, and thus remain for a longer duration of time within the retail outlet at which the transceiver 15 may be located.

The present invention therefore provides an information system that notifies a mobile device when the mobile device moves within predetermined range of a wireless hotspot, thus providing the user of the mobile device the opportunity to access the services provided at the wireless hotspot, which the user would otherwise not have done so if they had remained unaware of the presence of the wireless hotspot.

What is claimed is:

1. A communication system comprising notification means arranged to locate a mobile unit and to transmit a notification to said mobile unit via a first telecommunication network when said mobile unit moves within the vicinity of an access node of a second network.

2. A communication system according to claim 1, wherein said notification comprises a voice message or text message.

3. A communication system according to claim 1, wherein said notification contains the location of said access node.

4. A communication system according to claim 3, wherein the notification further comprises one or more from the list including the data transfer rate supported by the access node, details of the transmission coverage provided by the access node, the cost to a user of utilising the access node and details of goods and services available at the access node.

5. A communication system according to claim 1, wherein said notification contains directions to said access node.

6. A communication system according to claim 1, wherein said notification comprises an electronic token.

7. A communication system according to claim 6, wherein said electronic token has a redeemable monetary value.

8. A communication system according to claim 7, wherein said access node is located at a retail outlet at which said electronic token is redeemable.

9. A communication system according to claim 6, wherein said electronic token comprises a gaming credit.

10. A communication system according to claim 6, wherein said electronic token is transmitted only when said mobile unit is in communication with said second network.

11. A communication system according to claim 1, wherein said mobile unit is capable of communicating with both said first and said second networks, said mobile unit being capable of communicating with said second network only when within a predetermined range of said access node.

12. A communication system according to claim 1, further comprising a further mobile unit for communication with said second network, said further mobile unit being capable of communication with said second network only when within a predetermined range of said access node.

13. A communication system according to claim 11, wherein the rate of communication with said second network is at a higher data rate than the rate of communication with said first network.

14. A communication system according to claim 1, wherein the location of the access node is held on a storage medium in communication with said first network.

15. A communication system according to claim 1, wherein said first network comprises a cellular communication system.

16. A communication system according to claim 1, wherein said second network comprises a wireless LAN or a 3G pico-cell.

17. A telecommunication system comprising:
at least one base station for communication with at least one mobile communication device via a first wireless telecommunication network;
means for determining the location of the mobile communication unit;
means for accessing a data storage device having the location of at least one access point of a second wireless telecommunication network stored thereon; and
means for causing a notification to be transmitted to the mobile communication device first comes within a predetermined distance of the access point of the second wireless telecommunication network, the notification comprising an electronic token redeemable at the location of the access point.

18. A method of notifying a mobile device user to the presence of a network access node, the method comprising:
providing a first network in communication with said mobile device;
determining the location of said mobile device; and
transmitting a notification from said first network to said mobile device when said mobile device moves within the vicinity of a network access node of a second network.

19. A method according to claim 18, wherein said notification signal comprises a voice message or text message.

20. A method according to claim 18, wherein said notification signal contains the location of said access node.

21. A method according to claim 18, wherein said notification signal contains directions to said access node.

22. A method according to claim 18, wherein said notification signal comprises an electronic token.

23. A method according to claim 22, wherein said electronic token has a redeemable monetary value.

24. A method according to claim 23, wherein said electronic token is redeemable at a retail outlet at which said network access node is located.

25. A method according to claim 22, wherein said electronic token comprises a gaming credit.

26. A method according to claim 22, wherein said electronic token is transmitted only when said mobile unit is in communication with said second network.

27. A method according to claim 18, wherein the location of said at least one network external access node is held in a storage medium, said storage medium being in communication with said first network.

28. A method according to claim 18, wherein communication with said second network is achieved using said mobile device when said mobile device is within a predetermined range of said external access node.

29. A method according to claim 18, wherein communication with said second network is achieved using a further mobile device when said further mobile device is within a predetermined range of said external access node.

30. A method according to claim 28, wherein communication with said second network occurs at a greater data rate than communication with said first network.

31. A method of notifying a mobile communication device user to the presence of a network access point, the method comprising transmitting a notification to a mobile communication device via a first telecommunication network when that mobile communication device first moves within a predetermined distance of a network access point, wherein the notification comprises a reward redeemable at a retail outlet located at the network point.

32. A method of operating a wireless communication system, the wireless communication system comprising one or more access nodes to the wireless communication system, the method comprising providing details of the location of the or each access node to a further telecommunications network.
